(19) United States
(12) Patent Application Publication
(10) Pub. No.: US 2019/0357649 A1
(43) Pub. Date: Nov. 28, 2019

(54) Case for Portable Devices which Holds Removable Tools

(71) Applicants: Charles Joseph Becnel, Baton Rouge, LA (US); Jeffrey John McLean, Baton Rouge, LA (US)

(72) Inventors: Charles Joseph Becnel, Baton Rouge, LA (US); Jeffrey John McLean, Baton Rouge, LA (US)

(73) Assignee: Knyphe, LLC, Baton Rouge, LA (US)

(21) Appl. No.: 16/423,018

(22) Filed: May 26, 2019

Related U.S. Application Data
(60) Provisional application No. 62/677,011, filed on May 27, 2018.

(51) Int. Cl. A45C 15/00; B67B 7/16; A45C 11/00; A45D 24/10; B43K 31/00; B26B 29/02; B25H 3/00

(52) U.S. Cl. CPC A45C 15/00; B67B 7/16; A45C 11/00; A45D 24/10; A45C 2011/001; B26B 29/025; B25H 3/006; A45C 2011/002; A45C 2011/003; B43K 31/00

(57) ABSTRACT

People carry electronic devices on their person which have cases to protect electronic devices from falls. People also carry a variety of tools on their persons. Existing cases rarely have integrated tools and when they do the utility of the case and the tool are both reduced. The present invention is a protective case for electronic devices which securely stores tools inside the case. The tools are fully removable from the case. The tools are retained in the case by geometric interference between the tool and the case.

### STATEMENT REGARDING PRIOR DISCLOSURES BY THE INVENTOR OR A JOINT INVENTOR

This application claims the benefit of U.S. Provisional Application No. 62/677,011, filed on May 27, 2018, the entirety of which is hereby incorporated by reference.

### CROSS-REFERENCE TO RELATED APPLICATIONS

Provisional application No. 62/677,011, filed on May 27, 2018.

### STATEMENT REGARDING FEDERALLY SPONSORED RESEARCH

Not applicable to this application.

### BACKGROUND OF THE INVENTION

### Field of the Invention

The present invention relates generally to cases for portable electronic devices and more specifically to cases for portable electronic devices which contain removable tools.

Portable electronic devices are often protected from damage due to falls and impacts by a protective case. The case surrounds the sides of the electronic device without a display. The case is typically made of a polymeric material that absorbs the energy from the impact and prevents the electronic device from being damaged. Conventional cases serve the sole purpose of protecting the electronic device. Some cases have provisions for storing items such as credit cards, for supporting the electronic device at an angle for handsfree viewing, and for providing an additional battery.

### Description of Related Art

Mobile electronic devices are often protected from falls and impacts by protective cases. Cases are typically manufactured from polymers and typically serve the sole purpose of protecting the electronic device. Some cases include tools which are attached to the case. Other cases have additional features such as storing items such as credit cards or providing means for holding the device.

U.S. Pat. No. 8,483,786 entitled Case for Handheld Devices with One or More Integral Tools discloses a protective case for portable electronic that contains an integral bottle opener that may be extended and retracted while remaining attached to the case. While this provides a useable tool, the utility is reduced since it remains attached to the case. Additionally, the mechanism for extending and retracting the tool has several parts that increase the complexity of the case and may fail over time.

U.S. Pat. No. 9,654,605 entitled Accessory for Use with Electronic Device and Cover discloses a protective case that has an accessory compartment that contains items such as electronic components and or thin, flat items such as credit cards. While this embodiment allows electronic components and credit cards to be stored, tool storage is not claimed.

U.S. Pat. No. 9,756,916 entitled Protective Case with Card Storage discloses a mechanism for storing cards inside of a protective case. This embodiment utilizes moving components such as a rack and pinion gear set to move the cards into and out of the case. While functional, these moving parts complicate the system.

U.S. Pat. No. 8,418,852 entitled Compartmentalized Protective Case for Portable Handheld Electronic Devices discloses a case that has a compartment that can be opened and closed and stores things such as personal care items, cards, and keys. However, the compartment has to be fully opened to remove the stored items.

Others have developed protective cases that contain several tools which remain attached to the case. One such embodiment, U.S. Patent Application US2013/0069499 has a protective case that contains a plurality of tools. In this embodiment the tools are functional, but the electronic device is put at risk while the tools, particularly the knife, are being used.

### BRIEF SUMMARY OF THE INVENTION

The invention relates to cases for portable devices, and more particularly to cases which hold a fully removable tool. Both the case and tool can be decoupled and have full function. The current invention uses mechanical interference between the case and tool for retaining the tool within the case. The case with a tool retained with mechanical interference between the two objects solves the problem of cost and reliability of prior inventions which use multiple components to hold, accept, and release the tool.

### BRIEF DESCRIPTION OF THE SEVERAL VIEWS OF THE DRAWINGS

FIG. 1 is a perspective view showing the tool stored in the case.

FIG. 2 is a front view showing the tool stored in the case.

FIG. 3 is a front view showing the tool partially removed from the case.

FIG. 4 is a front view showing the tool fully removed from the case.

FIG. 5 is a front view with hidden lines showing the tool fully inserted into the case in the storage slot.

FIG. 6 is a section view looking from the front showing the tool in the storage slot in the case.

FIG. 7 is a section view looking from the end showing the extrusion of material from the case that provides geometric interference to retain the tool in the case.

FIG. 8 is a left side view of the case showing the tool in the storage position.

FIG. 9 is a right side view of the case showing the buttons and openings on the case.

FIG. 10 is a bottom view of the case showing the tool in the storage position as well as the openings in the case.

### DETAILED DESCRIPTION OF THE INVENTION

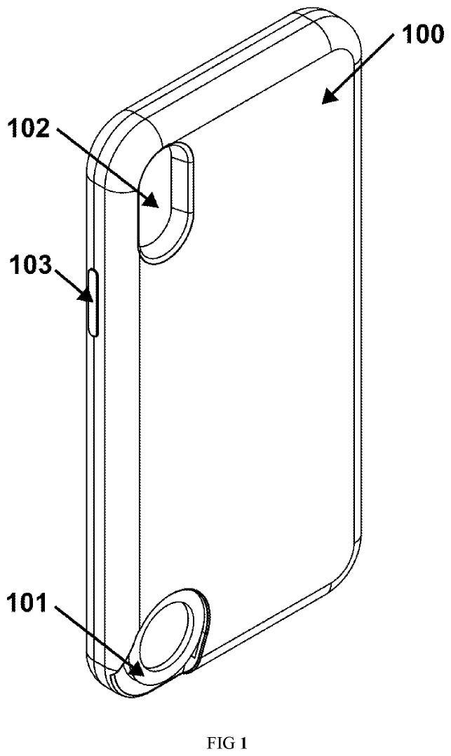

The present application is for a protective case 100 made of any rigid or semi-rigid material which protects portable electronic devices and stores one or multiple removable tools 101 as shown in FIG. 1. In the preferred embodiment, the case is made from an injection molded polymer. In other embodiments, the case may be made of wood, leather, or other materials. Examples of portable electronic devices include but are not limited to phones, smart phones, tablets, computers, music players, cameras, global positioning systems (GPS), etc. The case is formed in a way to protect the electronic damage such as falls, impacts, sharp objects. In the preferred embodiment of the case the electronic device is surrounded in part or whole by the case and holds the tool. In other embodiments the case does not protect the portable device and only stores the tool. The tool 101 may be used for one or multiple purposes. In the preferred embodiment, the tool is a knife. In other embodiments the tool may be a strap cutter, bottle opener, pry bar, wrench, scissors, pliers, a pen, a ruler, a comb, eating utensils, a multitool, or other similar tools.

As shown in FIG. 1, the case 100 has openings 102 and buttons 103 that allow for the full operation of the electronic device that is contained therein. The openings 102 are cutouts in the material that allow the electronic device to function as originally intended. The opening 102 in the embodiment shown in FIG. 1 allows the camera to operate as designed. Similar openings exist for the switches, speakers, microphone, and power connector.

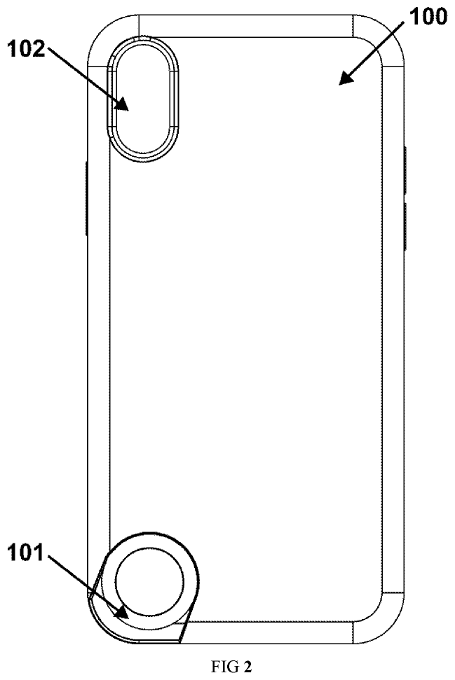

As shown in FIG. 2, the tool 101 is safely and securely stored in the case 100 in an internal slot in the case.

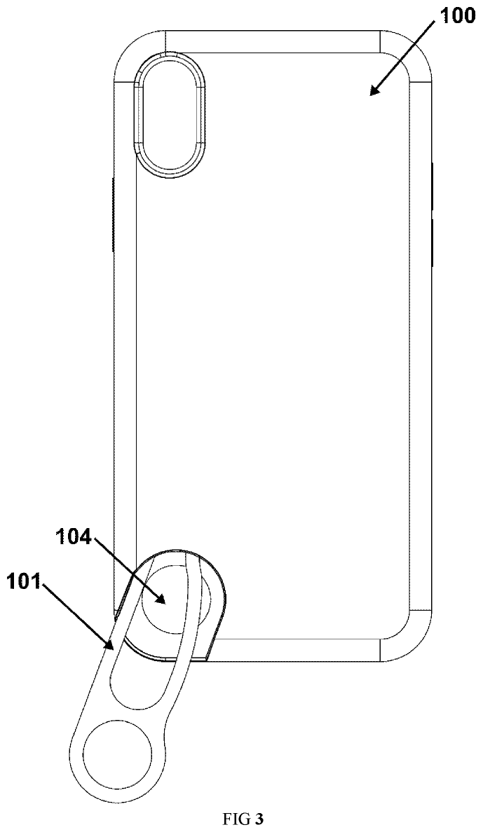

The tool 101 can be removed from the case 100 as shown in FIG. 3 by sliding the tool out of the case.

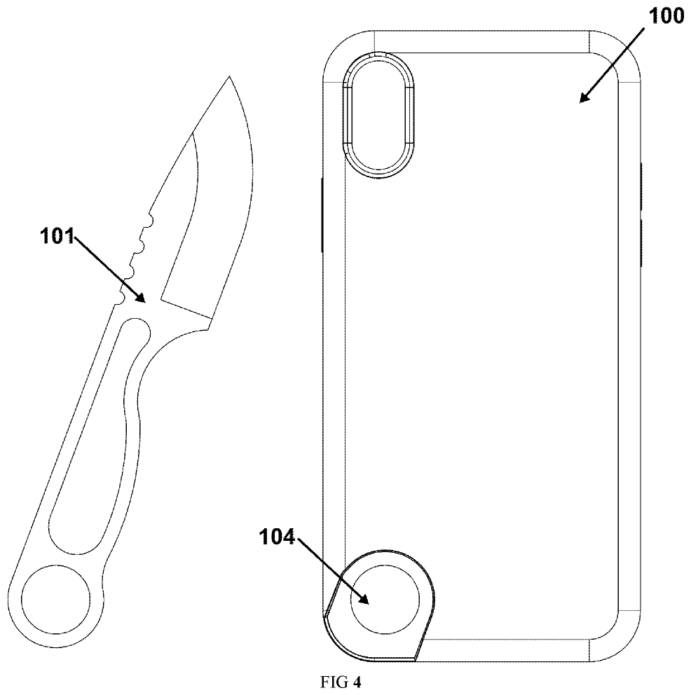

In FIG. 4, the tool 101 is shown fully removed from the case 100. The raised portion of the case 104 which provides mechanical interference and retains the blade is also shown. The outer diameter of the raised portion 104 is slightly smaller than the inner diameter of the circle in the handle of the tool 101. The raised portion of the case 104 thus fits into the circle in the handle of the tool 101 holding it in place. The height of the raised portion of the case 104 is designed such that the tool 101 can be removed when desired but does not slide out when the protective case 101 is held in a vertical orientation. In other embodiments, the raised portion of the case may be shapes other than circular as long as it matches the opening in the tool. In the preferred embodiment, the opening in the tool that mates with the raised portion 104 extends through the full thickness of the tool material. In other embodiments, the tool may have a blind pocket that mates with the raised portion 104 of the case.

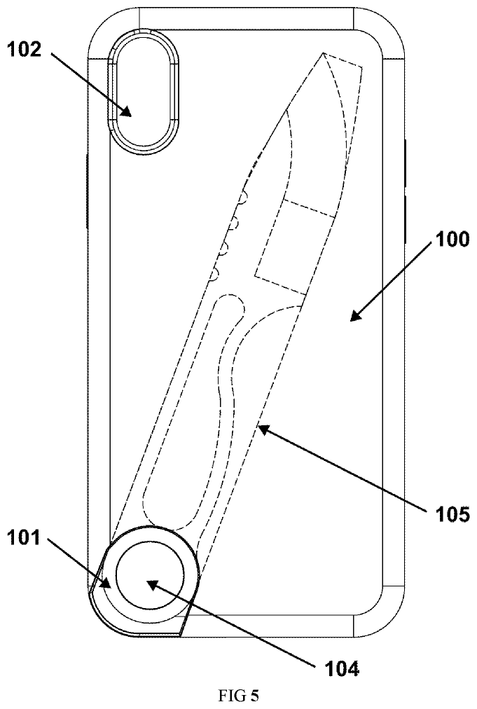

In FIG. 5, the tool 101 is shown using hidden lines where it is inserted into the case and is inserted into the slot 105 in the case 100 which holds the tool. The slot 105 has the same width as the tool to prevent the tool from moving relative to the case once fully inserted. Additionally, the slot 105 allows the tool to be fully inserted into the case regardless of the orientation. Thus, the tool 101 can be rotated 180 degrees about the longitudinal axis of the tool and inserted into the case 100. The orientation and location of the slot 105 can be adjusted for different electronic devices to avoid interference with the features of the device and to maximize the size of the tool.

In one embodiment of the mobile device case, the case has material which is removed to fully encompass the tool as shown in FIG. 5. In other embodiments, the protective case 100 may only partially encompass the tool 101 such that more of the tool is visible.

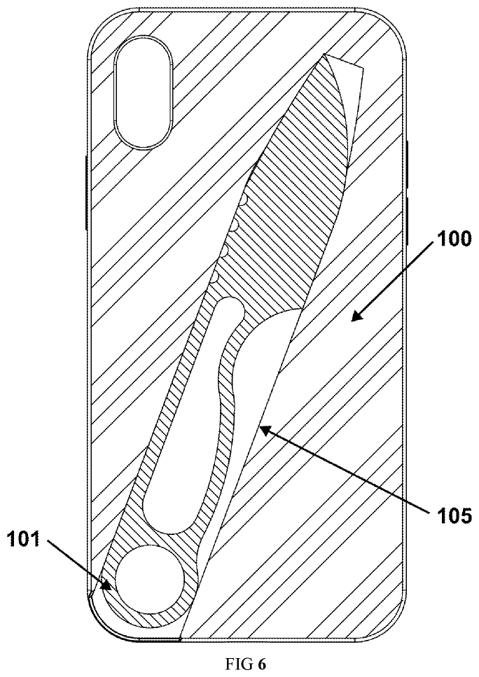

FIG. 6 is a section view that shows the tool 101 inserted into the slot 105 that houses the tool. In the preferred embodiment, the length of the slot 105 is such that it prevents the tool 101 from being inserted into the case 100 beyond the ideal position.

FIG. 6 shows the tool is secured in the case using the geometry of the combination of the case and tool with the aid of no additional components. The simplicity of this designs allows for reduced cost and increased reliability. The geometry used to hold the tool into place also allows the tool to be easily removed and reinserted. The raised portion of the case 104 fits into the recess in the tool 101 and prevents the tool from moving when the case 100 is held vertically.

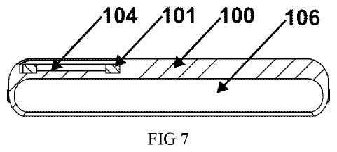

The tool is held in place by a raised portion of the case 104 which mates with a recess in the tool 101 as shown in the section view in FIG. 7. The raised portion of the case retains the tool but, once pressed, allows the tool to be removed from the case 100 by sliding the tool 101 parallel to the slot 105.

As shown in FIG. 7, the case 100 can be made in one piece of material. Alternatively, the case can be made from two or more pieces of material joined together mechanically, chemically, or by other means.

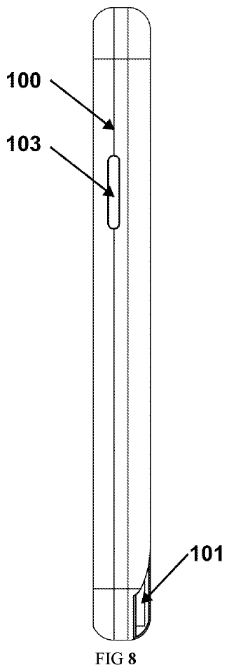

FIG. 8 shows the left side of the case 100 with the tool 101 stored in the case. The button 103 allows the user to control the electronic device stored in the case.

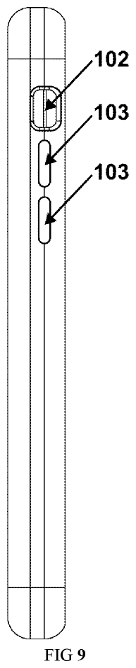

FIG. 9 shows the right side of the case which has an opening 102 and buttons 103 for operating the electronic device.

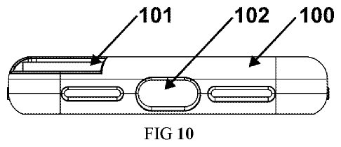

FIG. 10 shows the bottom view of the case 100 with the tool 101 in the storage position. Openings 102 exist in the case to allow the electronic device to work as intended.

What is claimed is:

1. A case which protects a mobile electronic device and holds a tool that is fully removable from the case.

2. The apparatus of claim 1 where the tool is held into the case and allowed to be removed and inserted using mechanical interference between the tool and the case.

3. The apparatus of claim 2 where the tool is held in place by the case with no moving parts.

4. The apparatus of claim 1 where the tool is comprised of a knife.

5. The apparatus of claim 1 where the tool is a strap cutter, bottle opener, pry bar, wrench, scissors, pliers, a pen, a ruler, a comb, eating utensils, a multitool or similar tool.

6. The apparatus of claim 1 where the tool slides into and out of the case.
